(19) United States
(12) Patent Application Publication
(10) Pub. No.: US 2008/0221791 A1
(43) Pub. Date: Sep. 11, 2008

(54) LANDMARK IDENTIFIER

(76) Inventor: Predrag Sukovic, Birmingham, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/683,469

(22) Filed: Mar. 8, 2007

(51) Int. Cl. G01C 21/30

(52) U.S. Cl. 701/211; 701/213

(57) ABSTRACT

The present invention provides a portable unit for identify landmarks based on the location of the landmark within a field of view. A controller determines the location of an area within the field of view and then communicates information about the location of an area to the user.

### BACKGROUND OF THE INVENTION

This invention relates to a landmark identifier, more particularly, this invention relates to a unit for relaying specific information to a traveler about a landmark or geographical area.

Travelers frequently desire to obtain information about their surroundings when traveling in an unfamiliar area. Some travelers rely on maps to identify unfamiliar surroundings. Maps are often times awkward to manipulate and provide limited information about these surroundings. Moreover, many travelers are unskilled in reading maps.

Travelers especially desire to obtain information about their surroundings if these surroundings include landmarks or are significant in some other way. To aid these travelers, some areas erect plaques or signposts to describe the significance of nearby surroundings. These plaques contain limited information and cannot be tailored to the traveler's specific preferences, e.g., providing the traveler with information tailored to the traveler. In addition, the plaques cannot be taken for the traveler to review at another time.

Some travelers participate in self-guided tours. These tours typically offer a prerecorded description of the various landmarks and locations on the tour. The traveler wears headphones or similar device to listen to the descriptions of the various landmarks. The traveler typically triggers the device to describe an new area. Although self-guided tours offer more detailed information than a map or plaque, these tours are limited in availability. The information is also not usually available for review at a later time as the user must return the device after completing the self-guided tour.

A handheld unit with Global Positioning System (GPS) capability may provide limited information to a traveler about a particular area, e.g., an address. In some situations the unit may identify a location, but typically provides very limited information. While these units provide some information to the user, the information is based on the coordinates of the GPS. Today's units do not provide information based on the location the user's line of sight.

It is desirable to provide detailed information about landmarks and locations to travelers on a portable unit. Further, it is desirable to allow the traveler, or another user, to customize the content they will receive on the portable unit. Further, it is desirable to base the information on the user's line of sight or on a particular area defined in part by the user.

### SUMMARY OF THE INVENTION

The present invention provides a portable unit for identifying landmarks based on the location of the landmark within a field of view. A controller determines the location of an area within the field of view and then communicates information about the location of an area to the user.

The portable unit, according to the present invention, establishes the location of the landmark within the field of view by utilizing a direction the camera is facing, an angle of the camera, and a Global Positioning System coordinate. The unit retrieves location specific information and displays the information based upon the location coordinates.

These and other features of the present invention can be best understood from the following specification and drawings, the following of which is a brief description.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic block diagram of a portable unit.

FIG. 2 is a rear view of the portable unit.

FIG. 3 is a perspective view of the portable unit and a landmark.

### DETAILED DESCRIPTION OF THE PREFERRED EMBODIMENT

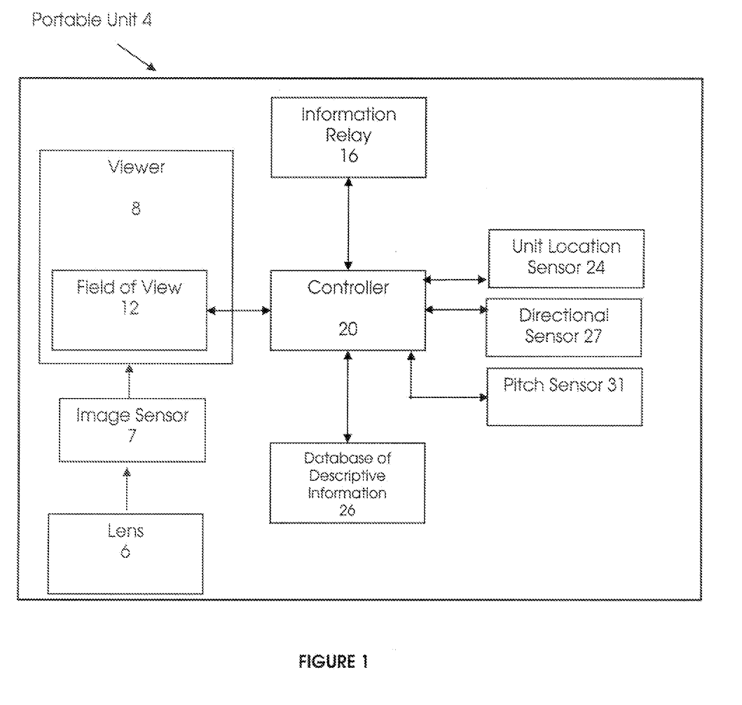

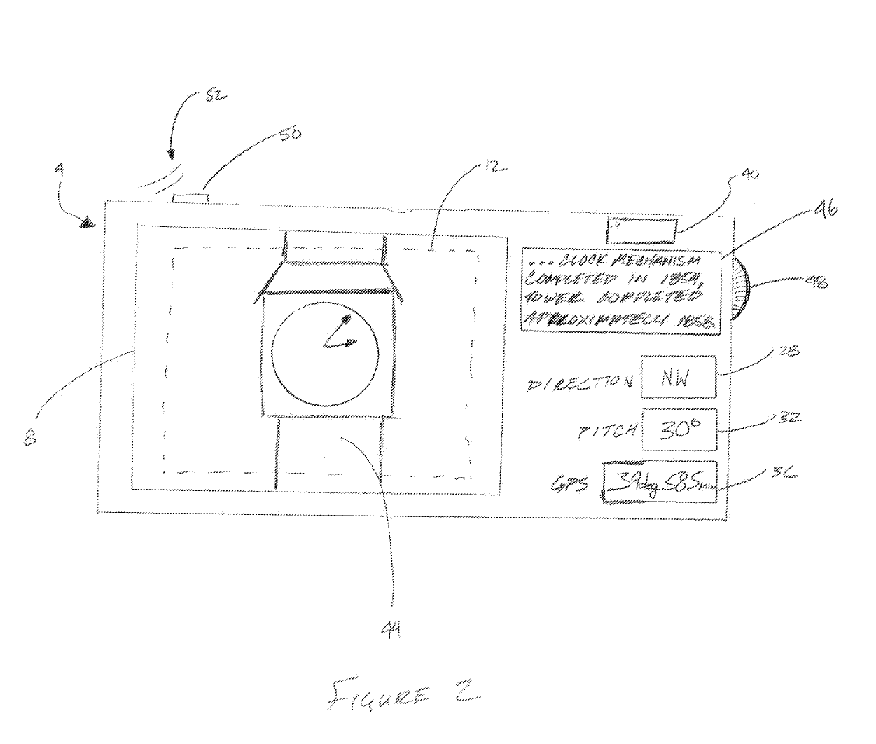

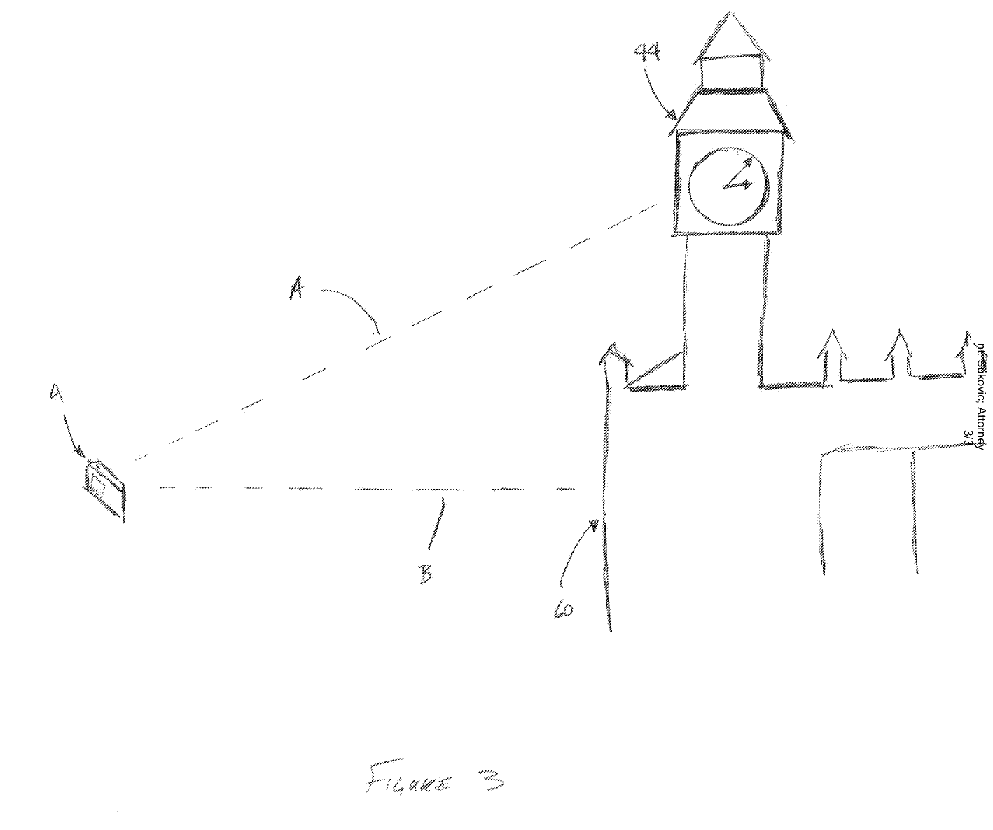

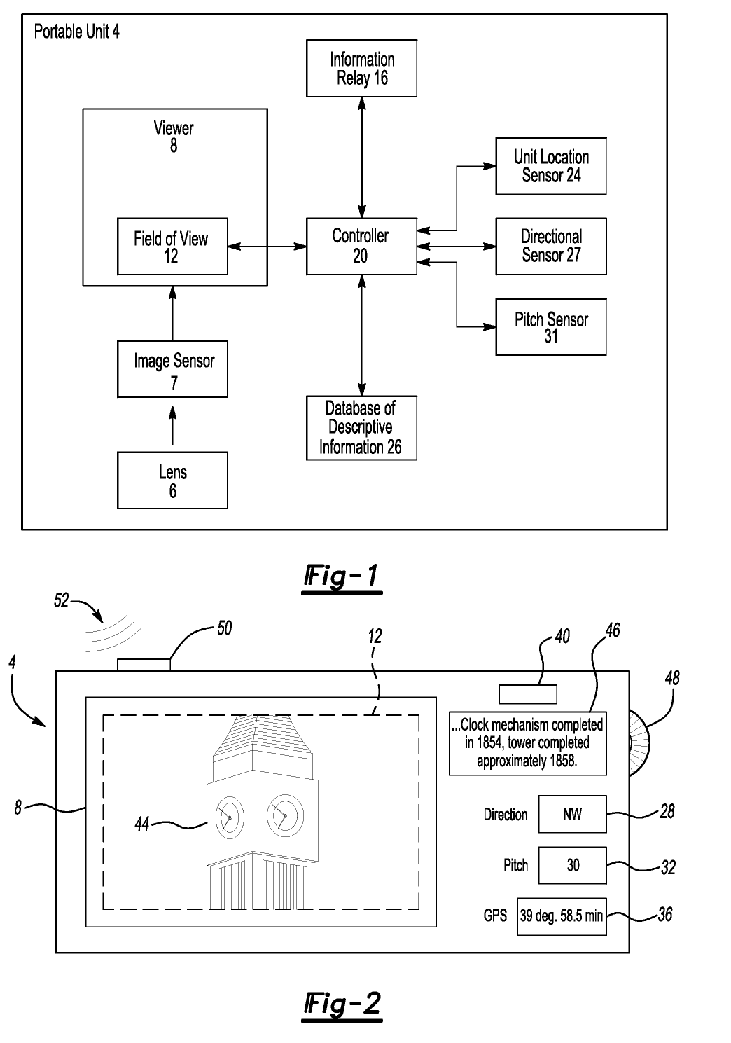

Referring to the schematic of FIG. 1, an inventive portable unit 4 includes a viewer 8 and a controller 20. The viewer 8 is any known display, such as an LCD, LED or other electronic display or may simply be an optical lens. The viewer 8 displays a field of view 12 received through a lens 6 by a CCD or other image sensor 7 (if electronic). If the viewer 8 is purely optical, an image sensor 7 is not required. The controller 20 may receive feedback from the lens 6 indicating the current focal length of the lens 6 (if it is a zoom lens 6).

The controller 20 receives information regarding the geographic location, orientation and pitch of the unit 4 from a location sensor 24, an orientation sensor 27 and a pitch sensor 31, respectively. The location sensor 24 may be or may include a GPS receiver, and/or other location-determining devices, such as differential GPS devices or those location determining devices currently included on some cell phones. The orientation sensor 27 may be or may include a compass and/or gyroscope or other device for determining orientation relative to the relevant reference frame (depending on the location sensor and the landmarks). The pitch sensor 31 may be or may include one or more accelerometers or other sensors for determining a pitch of the unit, specifically the pitch of the lens 6. If the unit 4 is installed in a vehicle, then dead-reckoning and map-matching techniques could also be used to determine (or supplement) location and orientation.

The controller 20 of the unit 4 communicates with a database 26 of descriptive information, which keys information about the landmarks (or other geographic locations) to the location of the landmarks. The location of the landmarks includes geographic location (e.g. latitude, longitude and elevation). The location information may also include the height of the landmark and even some shape information and/or color information.

Referring to FIG. 2, the rear of the unit 4 includes the viewer 8 and optionally several indicators, including a direction indictor 28, pitch indicator 32 and location indicator 36. Much like a digital camera, the user may also utilize a viewfinder 40 on the unit 4 to look through the lens 6 (FIG. 1) instead of relying on the viewer 8. The unit 4 further includes an information display 46 that may be scrolled through using a thumbwheel 48 (or other input device) located on the side of the unit 4. Alternatively, the unit 4 may communicate information to the user via the viewer 8 and/or audibly. A GPS receiver antenna 50 may be on the exterior of the unit 4.

In use, a user wishing to retrieve information about a particular location, such as a landmark within a foreign country, utilizes the lens 6 to select an image of the landmark for display on the viewer 8. By moving, orienting and tilting the unit 4, the user defines a field of view 12 on the viewer 8 that includes at least a portion of the landmark.

The controller 20 of the unit 4 communicates with the database 26. With the geographic location, pitch, orientation and (optionally) focal length of the lens 6 of the unit 4, the controller 20 can index the database 26 and determine what landmark 44 has been selected by the user in the viewer 8. Optionally, the controller 20 could supplement its determination with some image analysis (including shape and edge detection) of the image in the image sensor 7 to compare to corresponding information (shape and edge information) in the database 26. Once the controller 20 has identified the landmark 44 selected by the user relative to the database 26, the controller 20 communicates information from the database 26 regarding the landmark to the user via the display 46, the viewer 8 and/or audibly. For example the database 26 may store the name and some historical facts regarding the landmark 44 to be communicated to the user.

Because the controller 20 knows both the location of the landmark (based on the database 26) and the location of the unit 4, the controller 20 can determine the landmark shown on the field of view 12 within the viewer 8 by also analyzing the orientation (and optionally, the pitch and focal length) of the lens 6. The unit 4 then communicates the name of the landmark 44 and other information about the landmark 44 to the user. Thus, the user obtains information relating to the landmark 44 by capturing the image of the landmark on the field of view 12. In so doing, the user does not need to know the name of the landmark 44 to obtain information about the landmark 44.

The database 26 may be replaced or updated. For instance, the user may replace the database 26 by linking the unit 4 to a desktop computer when the user travels from a first country to a second country. After linking, the database 26 may contain facts and other related information relevant the second country's landmarks. Alternatively, the database 26 can be updated through a wireless link (e.g. wireless internet). The database 26 may be updated dynamically and automatically based upon the current location of the unit 4.

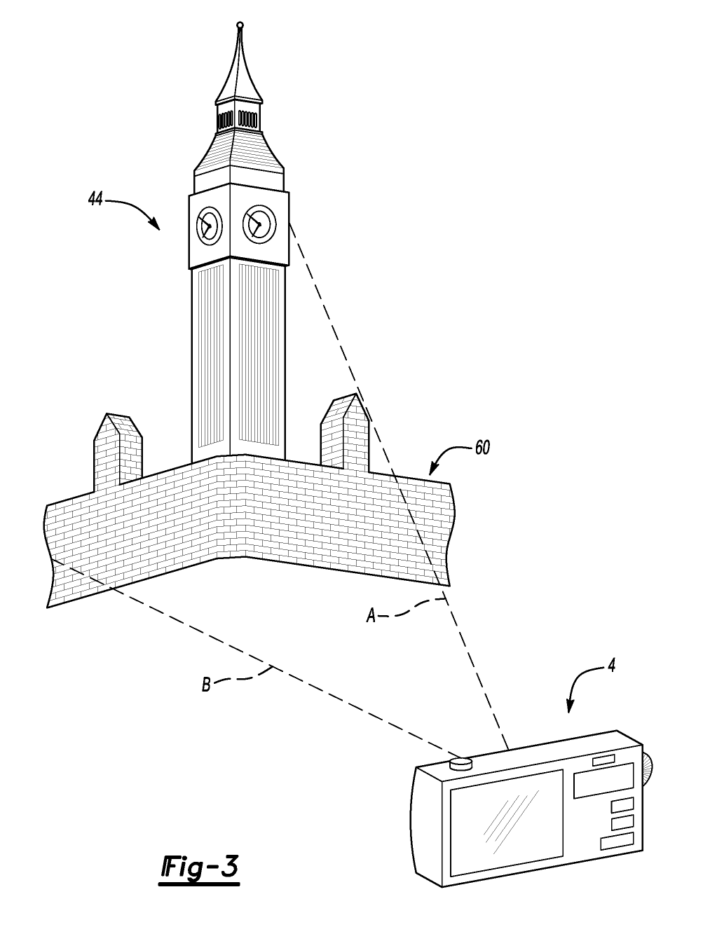

Even though the unit 4 may face in one direction, adjusting the pitch of the unit 4 may sometimes change the landmark 44 shown within the field of view 12. Referring now to FIG. 3 with continued reference to FIG. 1, the pitch sensor 31 provides the information necessary to distinguish between a landmark viewed when the unit 4 is positioned at a first angle, and a landmark viewed when the unit 4 is positioned at a second angle. In this example, the unit 4 displays the clock-tower 44 when the unit 4 is tilted at a first angle such that the field of view 12 is along line A. When the unit 4 is tilted at the second angle the field of view 12 is along line B and the viewer 8 shows a palace wall 60. Thus, when the unit 4 has a field of view along line A, the information display 46 shows information relating to the clock-tower 44. However, when the unit 4 has a field of view along line B, the information display 46 shows information specific to the palace wall 60.

In some situations, more than one landmark may be shown within the viewer 8, and the user may adjust the field of view 12 to the desired landmark. For example, if the field of view 12 included a portion of both the palace wall 60 and the clock-tower 44 the user could zoom in on the clock-tower 44 thereby indicating their wish to receive information relating to the clock-tower 44.

The user may also save a digital image of the field of view 12 for review at a later time. For example, if the user cannot immediately review the information on the information display 46, the user may save the image within the field of view 12 (the clock-tower 44) and recall it at a later time to review the information. In so doing, the user may later recall information relating to various landmarks.

Although described in terms of the landmark and the clock-tower 44, those skilled in the art, with the benefit of this disclosure, will understand that the present invention may be used to provide information for other structures and areas. For example, the example unit may be used to display information about buildings, mountains or lakes.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1) A portable unit for identifying landmarks, comprising:
a viewer for identifying a field of view;
a controller for determining a location of an area within said field of view; and
an information relay in communication with said controller, said information relay for communicating information to a user based upon said location of said area.

2) The portable unit of claim 1, wherein an electronic display includes said field of view.

3) The portable unit of claim 1, wherein a viewfinder identifies said field of view.

4) The portable unit of claim 1, wherein at least one of Global Positioning System unit, a pitch indicator, and a directional indicator communicate information to said controller.

5) The portable unit of claim 4, wherein said Global Positioning System unit indicates a positioning of said unit.

6) The portable unit of claim 5, wherein said controller calculates said location of an area using said positioning of said unit.

7) The portable unit of claim 4, wherein said directional indicator indicates a positioning of said unit.

8) The portable unit of claim 7, wherein said controller calculates said location of an area using said positioning of said unit.

9) The portable unit of claim 4, wherein said pitch indicator indicates a positioning of said unit.

10) The portable unit of claim 9, wherein said controller calculates said location of an area using said positioning of said unit.

11) The portable unit of claim 1, wherein said information relay displays information about said location of said area.

12) The portable unit of claim 1, wherein said information relay audibly communicates information about said location of said area.

13) A unit for retrieving location dependent information, comprising:
a viewer for defining a view of an area;
a controller in communication with said viewer, said controller operative to determine a location coordinate of said area;
an information relay for communicating information to a user, said information dependent upon said location coordinate.

14) The unit of claim 13, wherein said controller determines said location coordinate using a database of location information.

15) The unit of claim 13, wherein said controller determines said information using said location coordinate of said area and a location coordinate of said controller.

16) The unit of claim 15, wherein said controller uses at least one of a Global Positioning System coordinate, an angle indicator, and a directional indicator to determine said location coordinate of said controller.

17) The unit of claim 13, wherein said controller gathers said information from a database of descriptive information.
